(19) United States
(12) Patent Application Publication
(10) Pub. No.: US 2006/0023729 A1
(43) Pub. Date: Feb. 2, 2006

(54) Apparatus and method for adaptively controlling buffering amount according to content attribute in receiving audio-video data

(75) Inventors: Jun-hae Choi, Seongnam-si (KR); Cheol-hong An, Suwon-si (KR); Ho-jeong You, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/193,406

(22) Filed: Aug. 1, 2005

(30) Foreign Application Priority Data
Jul. 30, 2004 (KR) 10-2004-0060270

(51) Int. Cl. H04L 12/54

(52) U.S. Cl. 370/428

(57) ABSTRACT

An apparatus and method for adaptively controlling a buffering amount according to a content attribute in receiving audio-video data are provided. The method includes determining the number of frames to be stored according to frame information extracted from received packets, connecting and storing the packets by frames within a range of the determined number of frames, and outputting the packets connected and stored by frames to a decoder.

### CROSS-REFERENCE TO RELATED APPLICATION

This application claims priority from Korean Patent Application No. 10-2004-0060270 filed on Jul. 30, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to adaptively controlling a buffering amount according to a content attribute in receiving audio-video (AV) data.

2. Description of the Related Art

In the past several decades, video data and audio data have been transmitted via televisions in an analog format. However, due to diverse advantages of digital signals, more video information is getting expressed and recorded in a digital format. Recently, digital audio and video have been transmitted through satellite broadcast, terrestrial broadcast, or cable broadcast and users can view the digital audio and video using a set-top box and a television.

Meanwhile, along with the development of the Internet technology, video-on-demand (VOD) services such as Internet movies and Internet music stations have been rapidly growing. For example, a service provider transmits a movie, which is requested by a user using a computer, to the user in real time through the Internet and the user can view the movie on the computer. In both digital television and VOD service, users can play movies or music by receiving data in real time via the Internet or wireless connection.

Since digital data is large, studies on technology of compressing digital data with less information loss have been continued. The Joint Photographic Experts Group (JPEG) has suggested a standard for still images. H.261 and H.263 standards have been suggested for video coding. The Motion Picture Experts Group (MPEG) has suggested MPEG1, MPEG2, and MPEG4 standards and is also preparing an MPEG21 standard for video coding.

Video or audio data are usually used through a download or streaming scheme. In the download scheme, a file including video or audio data is stored in a local or personal storage device. In the streaming scheme, a file is not received, but video or audio data is output in real time. In the streaming scheme, data is output in real time theoretically, but a predetermined portion of data needs to be stored in a local area (such as a storage device or a digital device) in advance when considering a network state and a file attribute. Accordingly, a streaming client usually receives and stores data in a temporary storage device such as a buffer and then output the stored data. The time from when the streaming client requests video or audio data until the video or audio data stored in the buffer is output is referred to as an initial delay time. In addition, the video or audio data is stored in the buffer for a predetermined period of time, which is referred to as a delay time. A conventional streaming client defines the delay time as time taken to arithmetically fill a predetermined number of bits or a predetermined portion of a buffer and does not flexibly adapt to the attribute of actually received data.

### SUMMARY OF THE INVENTION

The present invention provides an apparatus and method for adaptively controlling the amount of data stored in a buffer in receiving AV data.

The present invention also provides an apparatus and method for controlling the amount of data stored in a buffer according to the attribute of AV data, thereby reducing a delay occurring in streaming of the AV data.

According to an aspect of the present invention, there is provided a method of adaptively controlling a buffering amount according to a content attribute in receiving AV data, the method comprising determining the number of frames to be stored according to frame information extracted from received packets, connecting and storing the packets by frames within a range of the determined number of frames, and outputting the packets connected and stored by frames to a decoder.

According to another aspect of the present invention, there is provided an apparatus for adaptively controlling a buffering amount according to a content attribute in receiving AV data, the apparatus including a frame builder connecting and storing received packets by frames, a frame building controller determining the number of frames to be stored in the frame builder according to frame information extracted from the packets, and a frame pusher outputting the packets connected and stored by frames in the frame builder to a decoder.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating the operation of a conventional streaming client;

FIG. 2 is a diagram showing an example in which frames are stored in a buffer at different data sizes according to an exemplary embodiment of the present invention;

FIG. 3 is a schematic diagram illustrating an example of the structure of a video stream;

FIG. 4 is a block diagram of a streaming client according to an exemplary embodiment of the present invention;

FIG. 5 illustrates the structure of packets and frames, which are managed by a frame builder, according to an exemplary embodiment of the present invention;

FIGS. 6A, 6B and 6C illustrate the changes in the frame builder from receipt of a packet until output of a frame, in an exemplary embodiment of the present invention;

FIG. 7 illustrates changes occurring in the frame builder and a frame building controller when the attribute of a frame changes, in an exemplary embodiment of the present invention;

FIG. 8 is a graph showing the amounts of frame data stored in the frame builder, in an exemplary embodiment of the present invention; and

FIG. 9 is a flowchart of a procedure in which a streaming client stores and outputs data in frame units according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

Before setting forth the exemplary embodiments of the invention, terms used in this specification will be briefly explained.

Frame

A frame is a set of lines comprising spatial information of an image signal. A single frame presents a single still image and a set of frames implement a video image. MPEG defines I-frames including independent image information and B-frames and P-frames which refer to information of other frames. In other standards, video coding is performed based on frames. Here, a frame is a data block into which a single still image is compressed and may be an independent still image or may refer to information of other frames.

Initial delay time

A streaming client requests data from a streaming server, receives the data from the streaming server, stores the data in a temporary storage device, and outputs a predetermined amount of data stored in the temporary storage device. An initial delay time is from the time when the streaming client requests the data to the time when the streaming client outputs the data. If the amount of data stored in a buffer is large, the initial delay time is long, but data is output without discontinuity because there is a large amount of data to be output initially.

Delay time

Streaming is a scheme of transmitting AV data via Internet or a wireless network and thus depends on a network speed. Accordingly, to output data without discontinuity, a streaming client needs to store a predetermined amount of data in advance to output. A delay time is time while data can be output in a state where no more data is received due to a network problem and may be time taken to output a predetermined amount of data stored in a buffer. When the delay time increases, the amount of data to be stored in the buffer also increases, but the data can be output seamlessly.

Streaming client

A streaming client generally indicates an apparatus that receives AV data transmitted from a server in a streaming scheme and reproduces the AV data. Computers, mobile telephones, digital televisions, personal digital assistants (PDAs), etc, may be streaming clients. A streaming client has a storage space (i.e., a buffer) to store a predetermined amount of streaming data or storing streaming data for a predetermined period of time and provides a function that decodes data that have been encoded according to various AV data coding standards.

Multimedia content receiver

There are various apparatuses reproducing multimedia contents. Examples of these apparatuses may be computers, household electrical appliances like digital televisions, laptop computers, PDAs, mobile telephones, and mobile televisions. In addition, a digital set-top box which receives and outputs multimedia contents may also be an example of a multimedia content receiver.

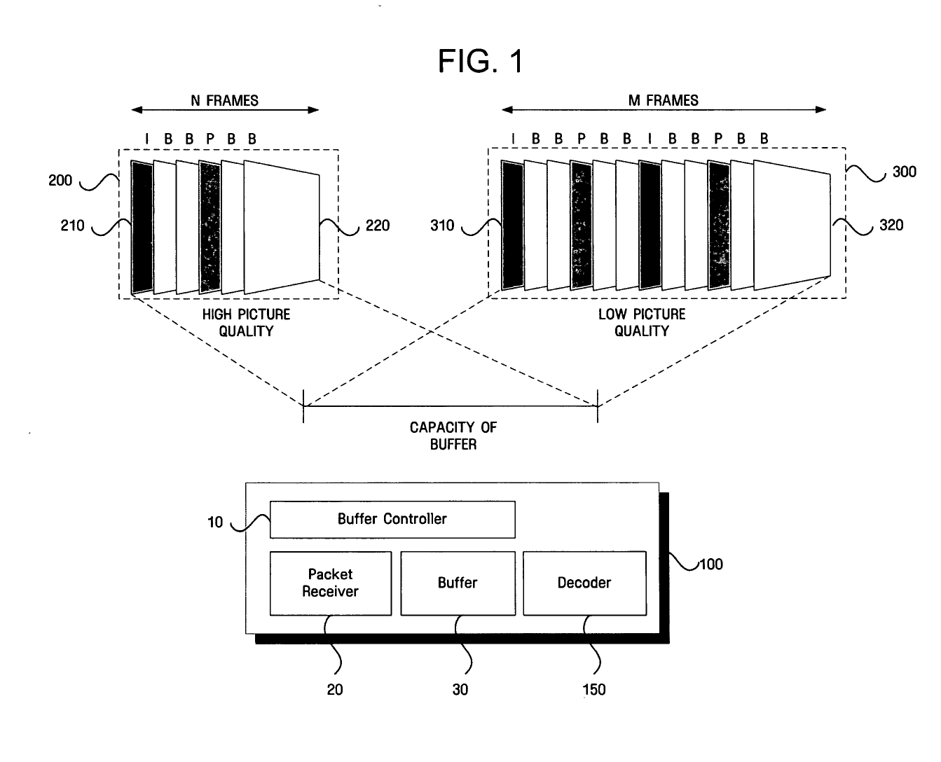

FIG. 1 is a block diagram illustrating the operation of a conventional streaming client 100. FIG. 1 illustrates that there is a difference between receiving high bit rate frames 210 and 220 providing high picture quality and receiving low bit rate frames 310 and 320 providing low picture quality. The conventional streaming client 100 includes a packet receiver 20 receiving data from a server, a buffer 30 temporarily storing the received packet, a buffer controller 10 controlling the amount of data stored in the buffer 30, and a decoder 150 performs decoding to output AV data contained in the packet.

The buffer 30 is a space for storing a predetermined amount of data for an initial delay time or a delay time. A maximum limit of the amount of data stored in the buffer 30 is determined in accordance with the size of a received packet. For example, the maximum limit is determined by whether the amount of data in a received packet satisfies a predetermined capacity like 2 Mbytes or 3 Mbytes.

In this situation, the capacity of the buffer 30 does not exactly indicate the delay time with respect to high bit rate data and low bit rate data. For example, according to the MPEG2 standard, data can be generated in two formats: high definition (HD) and standard definition (SD). The amount of information expressing a single frame, i.e., a data size is greater in the HD format than in the SD format. For example, when 1-Mbyte HD data is displayed for 30 seconds, 1-Mbyte SD data may be displayed for 50 seconds longer than 30 seconds.

The capacity of the buffer 30 may be set taking account of only a delay time necessary to processing HD data. For example, when the delay time for HD data is 1 minute, the capacity of the buffer 30 may be set to 2 Mbytes. In this case, 2-Mbyte SD data corresponding to a duration of 1 minute and 40 seconds is needed to fill the buffer 30. However, the streaming client 100 has set the buffer 30 based on the 1-minute delay time, and therefore, when SD data is received, more data corresponding to a duration of 40 seconds is needed. As a result, a user's demand for quick output through SD data may not be satisfied. Referring to FIG. 1, to fill the buffer 30 of the streaming client 100, N frames 210 and 220 are needed when high bit rate data is received while M frames 310 and 320 are needed when low bit rate data is received, where N<M. In the conventional technology, the buffer 30 is controlled based on only the size of data without considering a content attribute.

To overcome this limitation, in the present invention, the amount of data to be stored in the buffer 30 is controlled according to the attribute of received content so that the streaming client 100 can appropriately adjust the delay time.

A content attribute includes picture quality. In case of high picture quality, the size of data of a single frame is large. On the contrary, in case of low picture quality, the size of data of a single frame is restricted. In addition, a content attribute includes the number of frames per second. When data is created at a rate of 30 frames per second and the delay time is 30 seconds, it is needed to store 900 frames of data in the buffer 30. However, when data is created at a rate of 25 frames per second, it is alright to store only 750 frames of data in the buffer 30.

In addition to these attributes, whether seamless transmission or quick playback is important for content may be considered when data is stored in the buffer 30. When seamless transmission is important for the content, many frames need to be stored in the buffer 30. When quick playback is important for the content, it is needed to set the delay time to be short as only minimum necessary frames are stored in the buffer 30 so that buffering takes not much time at all.

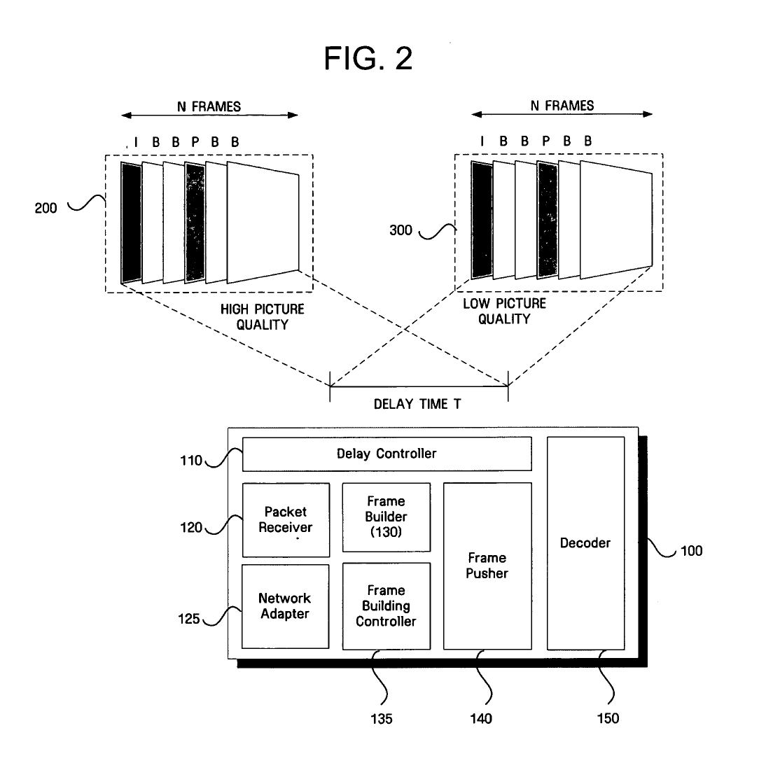

FIG. 2 is a diagram showing an example in which frames are stored in the buffer at different data sizes according to an exemplary embodiment of the present invention.

Picture quality can be determined based on how much data is needed to construct a frame when video is coded using the same method. When a single frame is represented with 3-Mbyte data, the frame contains much more information and thus has a higher picture quality than a frame represented with 1-Mbyte data. For example, in MPEG, picture quality may be compared between I-frames, between P-frames, or between B-frames, but it is inappropriate to compare picture quality between an I-frame and a P-frame or a B-frame. Two video data 200 and 300 shown in FIG. 2 are coded at the same rate of frames per second using the same method but are different in the amount of data representing a single frame.

When the streaming client 100 sets a delay time to T seconds, N frames are needed to fill T seconds with respect to both of the high bit rate data 200 and the low bit rate data 300 because N frames are needed to play video for T seconds. Although the number of frames which is needed is the same, the low bit rate data 300 has a smaller bit rate per frame and thus has a smaller amount of data to be stored in the buffer 30 than the high bit rate data 200. Accordingly, when the low bit rate data 300 is received, time taken to store data in the buffer 30 can be reduced with the same delay time as that applied to the high bit rate data 200. This fact can be easily inferred when it is considered that M frames of the low bit rate data 300 are needed and N<M in the conventional technology shown in FIG. 1.

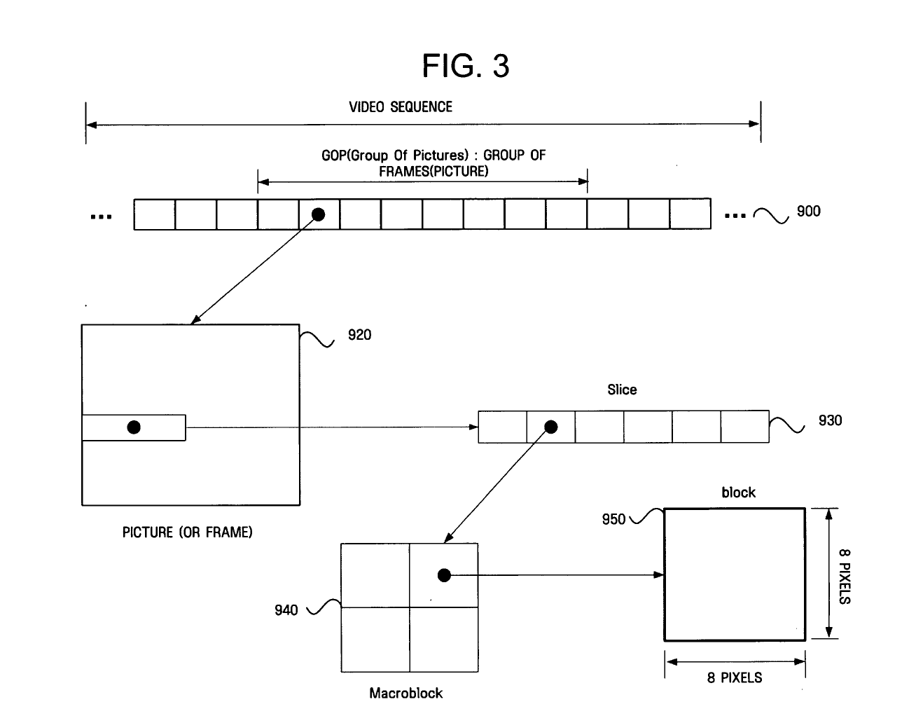

FIG. 3 is a schematic diagram illustrating an example of the structure of a video stream. MPEG2 video data is utilized as an example in FIG. 3. MPEG2 video data is comprised of a data sequence 900. The data sequence is based on a bit stream and includes information on a picture (hereinafter, referred to as a “frame”) 920. The frame 920 represents information on a single still image and is comprised of plural slices 930. Each slice 930 is comprised of plural macroblocks 940. Each macroblock 940 includes a block 950 containing information on pixels. In MPEG2, video information has the above-described structure and other coded video data also has the similar structure to that shown in FIG. 3.

To stream video, it is necessary to receive the video sequence. Frames and header information included in the video sequence have a large amount of data that cannot be transmitted or processed in a single bundle of data at present communication and data processing speed. Accordingly, the video sequence is divided into packets having a predetermined length and transmitted in packet units.

A packet is a unit having a predetermined length (that may be variable or fixed) by which a video stream comprised of bit streams is divided. MPEG2 defines a transport stream consisting of fixed length packets and a program stream consisting of variable length packets. The transport stream can transport many programs at one time, but data may be lost. The program stream is optimized to multimedia applications. Accordingly, multimedia data is transmitted using the above-described packets.

Meanwhile, there is a data unit used for communication. Such data unit may be referred to as a packet. The data unit for communication varies with a communication state and a protocol and the definition of data is different in a Transmission Control Protocol/Internet Protocol (TCP/IP), a User Datagram Protocol (UDP), a HyperText Transfer Protocol (HTTP), etc.

A transport stream packet has a length of 188 bytes. For example, in a communication protocol having a transmission unit of 1024 bytes, 5 transport stream packets can be sent.

Packets described below are sorts of bit streams into which a video stream is divided. A data unit transmitted through communication includes additional information such as a header and multimedia information corresponding to data actually desired to transmit. Accordingly, a bit stream transmitted as a part of multimedia information, e.g., a video stream is referred to as a packet.

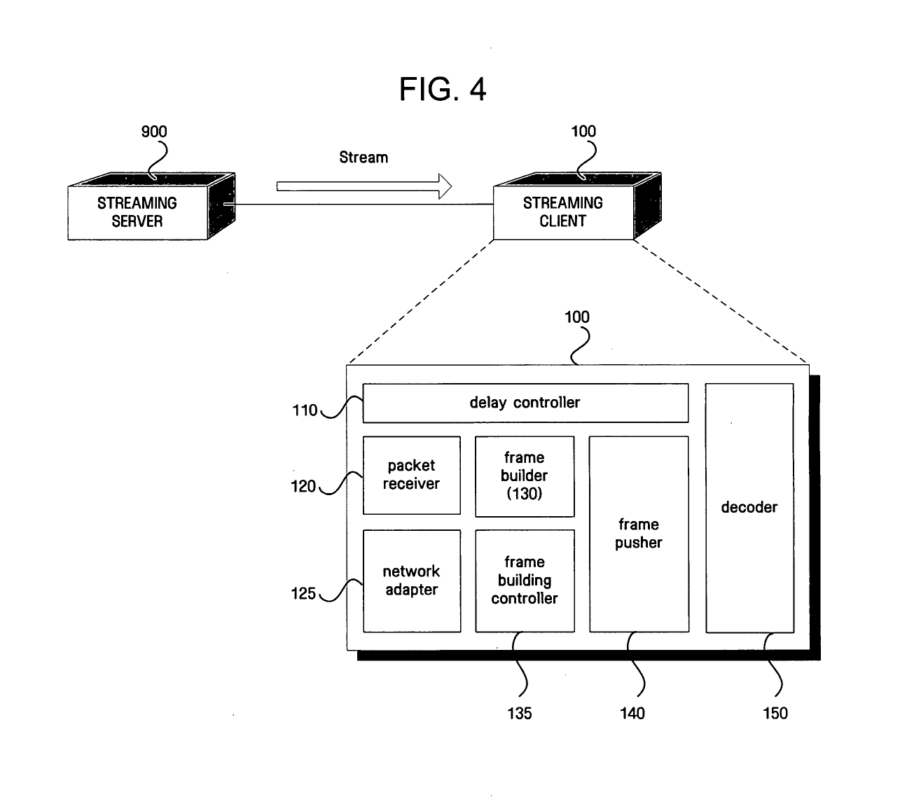

FIG. 4 is a block diagram of a streaming client 100 according to an exemplary embodiment of the present invention.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they are executed on one or more computers in a communication system.

The streaming client 100 includes a delay controller 110, a packet receiver 120, a network adapter 125, a frame builder 130, a frame building controller 135, a frame pusher 140, and a decoder 150. The streaming client 100 receives data streamed from a streaming server 900. As described above, the data is a packet included in a frame and is a part of the video stream described with reference to FIG. 3. Plural packets are needed to form a single frame if a packet has a smaller size than a frame. If coding technology with respect to a network and multimedia is enhanced, a single packet may include information on at least one frame. In addition, according to the characteristics of content, a single packet may also include information on at least one frame.

In other words, forming a single frame using at least two packets is based on conventional technology and a plurality of packets is not inevitably needed to form a single frame. In exemplary embodiments of the present invention, at least one packet is needed to form a single frame. However, it is just an example and the present invention is not restricted thereto. Afterwards, as technology regarding network and frame coding is developed, a single packet may include plural frames. The present invention can also be used in this case.

The streaming client 100 transmits and receives data to and from the streaming server 900 through the network adapter 125. Meanwhile, if the streaming client 100 only receives data from the streaming server 900, the network adapter 125 performs only packet reception and data request.

The data received through the network adapter 125 is transmitted to the packet receiver 120. The data received by the packet receiver 120 is a bit stream. With respect to the bit stream, as described above, it is assumed that a single frame is divided into plural packets when it is transmitted and the plural packets need to be combined to form the frame. Accordingly, unlike a conventional technique of immediately storing a received packet in a buffer, the packet is transmitted to the frame builder 130, which manages the received packet with respect to a corresponding frame.

Received packets can be managed with respect to each frame using frame information extracted from each packet. For example, if frame information extracted from a packet contains the header of a frame, the packet is the beginning of a new frame, and therefore, the packet is linked to a new frame on a frame management list. If the packet does not include the header of a frame, the packet is included in the same frame as a previous packet, and therefore, the packet may be combined with a current connection list of packets through a link or may be sequentially stored at a portion subsequent to a portion where the previous packet is stored.

For the sequential storing, the frame builder 130 may combine bit streams received from the packet receiver 120. Combining is building a bit stream of a single frame by adding received packets.

The frame pusher 140 continuously checks the number of frames stored by the frame builder 130. When the number of frames reaches a predetermined count, the frame pusher 140 brings the frames in the frame builder 130 and pushes them to the decoder 150. In other words, the frame pusher 140 transmits a frame combined by the frame builder 130 to the decoder 150 in the form of a bit stream. This operation is similar to transmitting packets stored in a conventional buffer in the form of a bit stream and the decoder 150 may receive data from the frame pusher 140 in the same manner as a conventional decoder receives the data from the conventional buffer. After starting the push, the frame pusher 140 continues the push until no data is present in the frame builder 130 or until a user requests to stop playback. To provide seamless multimedia playback for a user, the push rate of the frame pusher 140 and the receiving rate of the packet receiver 120 can be controlled by the delay controller 110.

If a received packet is simply a portion of a video or audio stream, it may be just additionally stored. If the received packet is not a portion of a video or audio stream but includes other information, it may be appropriately processed before being sequentially stored.

The decoder 150 performs decoding to output a frame and transmits a decoding result to a display unit or an audio output unit. Here, operations related with video or audio decoding are needed.

The frame building controller 135 determines and stores information on the number of frames to be stored in the frame builder 130 and information on a delay time. The information on the number of frames may include maximum and minimum numbers of frames that can be accommodated by the frame builder 130 and the number of frames needed for initial output. The frame building controller 135 may additionally store information on quality of picture. Such information corresponds to an attribute of a frame. According to the attribute, how many frames will be stored can be determined. For example, if the delay time has been set, the number of frames to be stored can be determined according to the attribute of a received frame. For example, if the delay time has been set to 1 minute and a received frame has been coded at a rate of 25 frames per second, the frame building controller 135 determines 1500 as the number of frames to be stored in the frame builder 130. In addition, a maximum or minimum frame count may be set based on a maximum or minimum delay time, respectively, and the attribute of a frame.

In case of high picture quality, since a large amount of packets needs to be received, discontinuity may increase due to delay. To overcome this problem, the frame building controller 135 may increase a storable frame count. Conversely, in case of low picture quality, the frame building controller 135 may decrease the storable frame count. The storable frame count can be differently set according to a system and multimedia content. The cases of high picture quality and low picture quality are just examples, and the present invention is not restricted thereto.

If the number of frames comprised of packets stored in the frame builder 130 is greater or much less than the storable frame count set by the frame building controller 135, the delay controller 110 controls a packet receiving rate and a packet push rate. For example, if the number of frames stored in the frame builder 130 is less than the minimum frame count set by the frame building controller 135, fast transmission may be requested so that more frames are transmitted to the frame builder 130. If it is difficult to realize fast transmission, the frame push rate may be decreased so that frames more than the minimum frame count are present in the frame builder 130. The delay controller 110 can control the push rate by controlling the frame pusher 140 and can control the receiving rate by controlling the reception of data from the streaming server 900 through the network adapter 125.

Conversely, if the number of frames stored in the frame builder 130 exceeds the maximum frame count, the frame builder 130 may not manage the stored frames. In this case, the streaming client 100 may request the streaming server 900 to reduce or stop data transmission for a moment. In streaming technology, if the streaming client 100 brings data using a pull strategy, the streaming client 100 can perform flow control, and therefore, the delay controller 110 can control an operation related with data reception. Even when the streaming server 900 transmits data to the streaming client 100 using a push strategy, if a protocol allowing the streaming client 100 to control a data rate is used, the delay controller 110 can request the streaming server 900 to stop data transmission or to send data at a lower transmission rate through the network adapter 125.

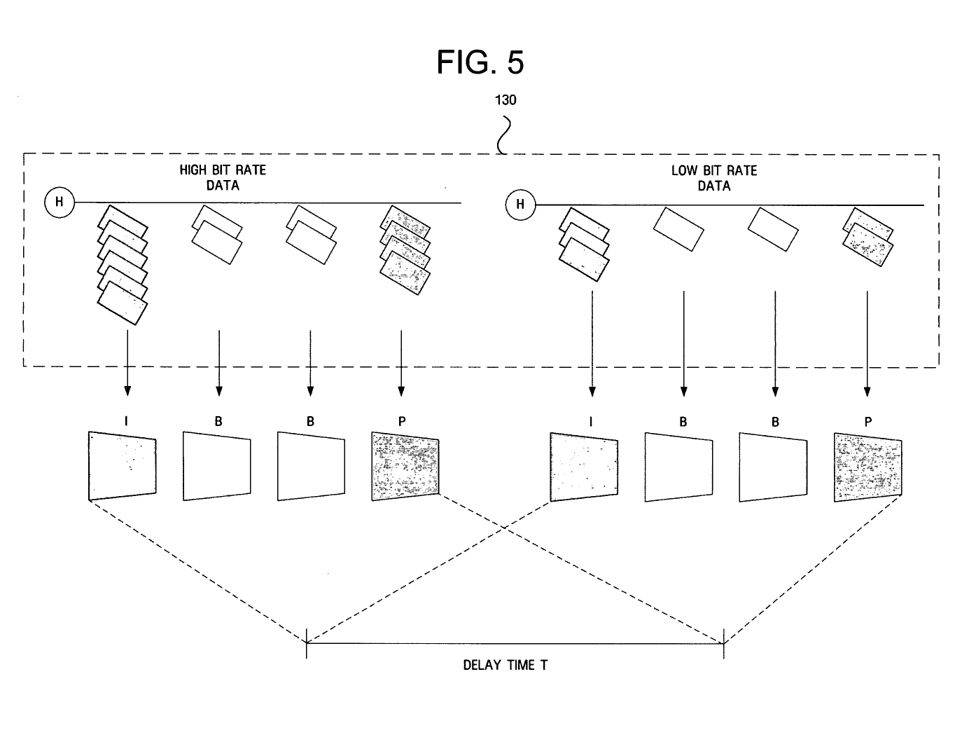

FIG. 5 illustrates the structure of packets and frames, which are managed by the frame builder 130, according to an exemplary embodiment of the present invention. In an exemplary embodiment illustrated in FIG. 5, a single frame is comprised of at least one packet.

The frame builder 130 can store packets received from the packet receiver 120 with respect to each frame. The frame builder 130 can determine whether a received packet is the header of a frame. If the received packet is the header of a frame, a new connection list may be created. If the received packet is not the header of a frame, the received packet may be connected to an existing connection list through a link, which is referred to as a link scheme. In another exemplary embodiment, information on a start position of each frame may be kept through a frame management list, and packets may be added with respect to a corresponding frame since the packets are bit streams. This scheme is referred to as a combination scheme.

In the link scheme, if k packets are needed to form a single frame, the k packets may be connected through a link and stored. The headers of respective packet links may be connected in order in which the packet links are input to the decoder 150. When a single frame has been comprised of k packets, information on the number of frames stored in the frame builder 130 is changed. This information is stored in the frame building controller 135. The frame building controller 135 may further set a frame count corresponding to a maximum or minimum delay time.

When the number of frames satisfying the delay time T is four at a certain rate of frames per second, the number of packets included in each frame varies with quality of picture, i.e., a bit rate.

Referring to FIG. 5, the frame builder 130 creates a connection list of packets for each frame and manages header packets of respective frames using another connection list. However, in another exemplary embodiment of the present invention, packets may be combined into a frame and a connection list may be created for each frame, by using the combination scheme.

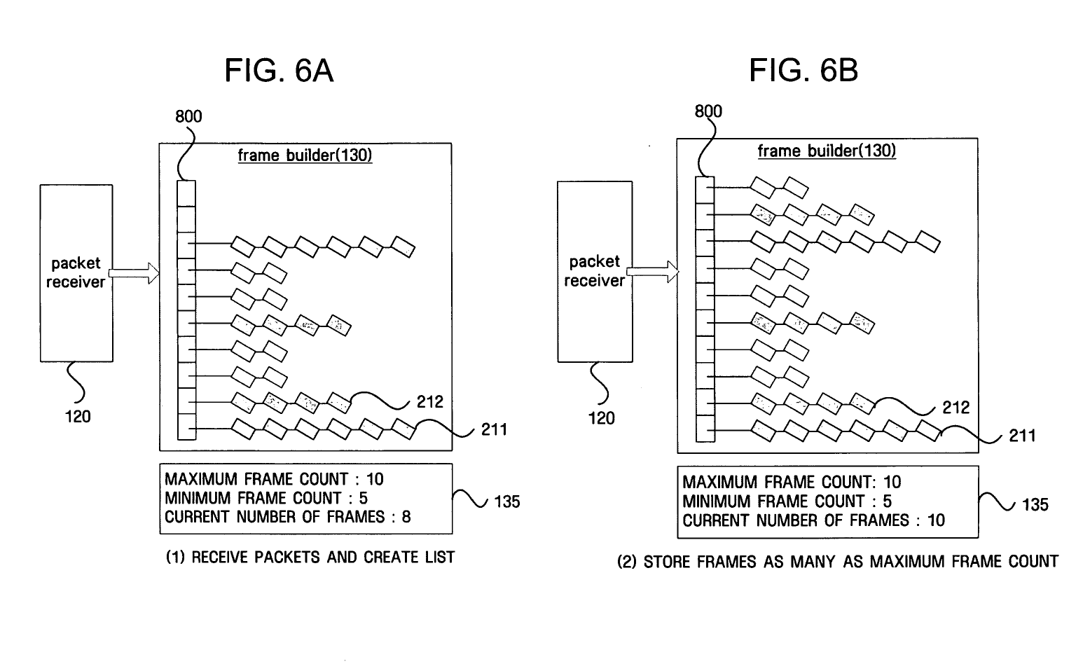

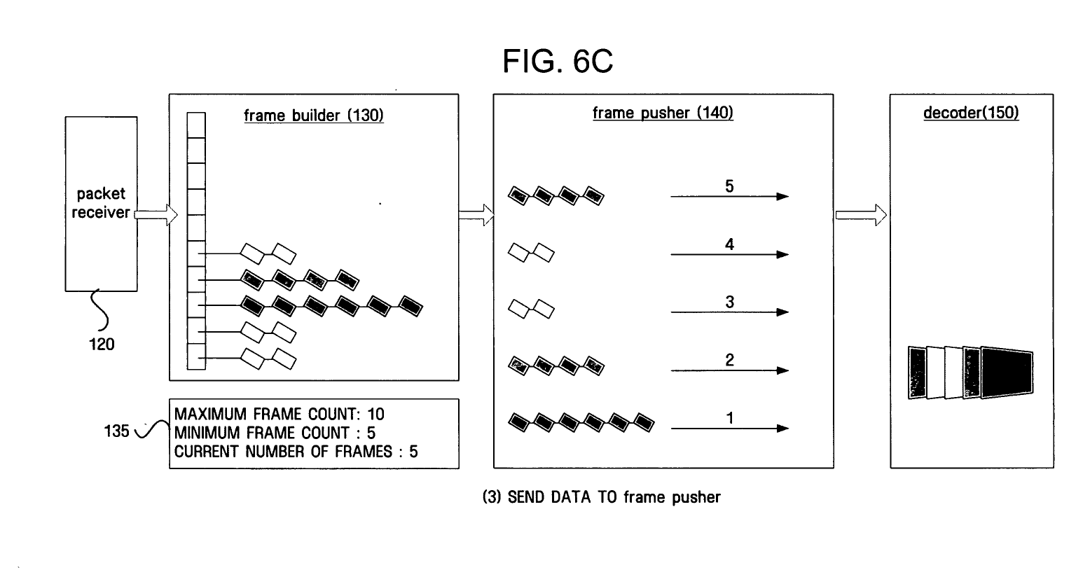

FIGS. 6A, 6B and 6C illustrate the changes in the frame builder 130 from receipt of a packet until output of a frame, in an embodiment of the present invention. Stages (1), (2), and (3) show how packets received in a temporal sequence are stored and output.

In stage (1) of FIG. 6A, the packet receiver 120 stores packets. Whether a packet is a start packet or an end packet of a frame can be determined based on the header of the packet. When the packet is the start packet, the frame builder 130 arranges a set of packets 211 or 212 forming a single frame, for example, a list which connects packets forming a single frame or sequentially stored packets, and creates a new connection to a frame management list 800 to form another frame. The set of packets is a connection of packets comprised of bit streams. The set of packets may be obtained by sequentially storing packets in a storage space. With respect to the sequentially stored packets, the frame management list 800 keeps a pointer indicating a position where a header packet of a frame is stored so that the frame pusher 140 can take the frame.

In stage (1) of FIG. 6A, the number of frames stored in the frame builder 130 is greater than a minimum frame count and less than a maximum frame count. The frame building controller 135 has information on the maximum and minimum frame counts. The information on the maximum and minimum frame counts is needed to control a receiving rate. Information needed to control the receiving rate does not necessarily contain the maximum and minimum frame counts but may contain only a storable frame count according to a system structure.

In stage (2) of FIG. 6B, as many frames as the maximum frame count have been stored in the frame builder 130. In this situation, the frames stored in the frame builder 130 must be output to store packets received by the packet receiver 120 afterwards. Accordingly, the frame pusher 140 takes packets from the frame builder 130 and sends the packets to the decoder 150 such that the number of frames comprised of packets left in the frame builder 130 is at least the minimum frame count. The frame pusher 140 takes the packets of each frame according to a frame sequence on the frame management list 800. The frame pusher 140 can take the packets in order in accordance with a link if the packets are connected using the link scheme. Alternatively, if the packets have been stored sequentially, the frame pusher 140 can take the packets in the order in which they have been stored. Accordingly, the packets 211 and packets 212 that have been stored prior to the other packets are output first. The frame pusher 140 may construct a frame using packets and send the frame to the decoder 150. Here, the frame pusher 140 may take packets corresponding to a single frame from the frame builder 130, convert the packets into a frame, and send the frame to the decoder 150. If the frame pusher 140 has a wide storage space, the frame pusher 140 may take a number of packets constituting a predetermined number of frames at one time and construct the corresponding frames. Such operation of the frame pusher 140 may vary with a system structure.

In stage (3) of FIG. 6C, since the current number of frames stored in the frame builder 130 is less than the maximum frame count, the frame builder 130 can receive more packets. While the frame builder 130 is receiving packets, the frame pusher 140 can continuously take packets from the frame builder 130 and send them to the decoder 150. During this operation, a flow control can be performed such that the current number frames stored in the frame builder 130 is at least the minimum frame count and is not greater than the maximum frame count.

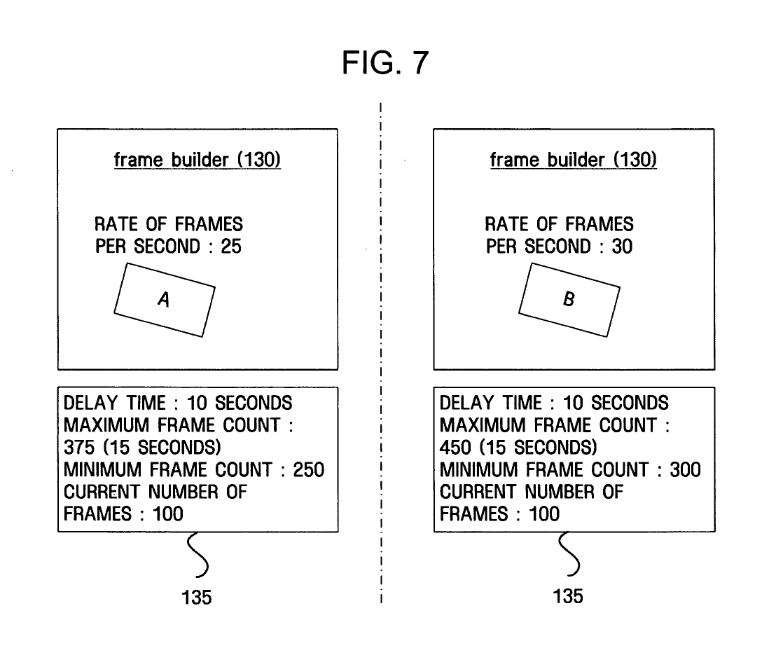

FIG. 7 illustrates changes occurring in the frame builder 130 and the frame building controller 135 when the attribute of a frame changes, in an exemplary embodiment of the present invention.

The maximum frame count and the minimum frame count set by the frame building controller 135 may vary with types of media because a rate of frames per second may be different according to content. Referring to FIG. 7, content A has a rate of 25 frames per second. Accordingly, when a delay time is 10 seconds, the minimum frame count is set to 250, and the maximum frame count is set to 375 based on an estimated maximum delay time of 15 seconds. Content B has a rate of 30 frames per second. Accordingly, when the delay time is 10 seconds, the minimum frame count is set to 300, and the maximum frame count is set to 450 based on an estimated maximum delay time of 15 seconds. As described above, since the delay time can be maintained constant even if a content attribute is different, unnecessary buffering can be prevented.

Meanwhile, in exemplary embodiments of the present invention, information needed to form a frame is not necessarily a rate of frames per second. For example, a value of a field defining a picture quality characteristic, such as HD or SD, may be used. If contents encoded at the same rate of frames per second have different picture quality, i.e., high picture quality and low picture quality, information regarding on the rate of frames per second and picture quality may be contained in a frame header.

In addition, the number of frames to store may be determined based on the size of information constituting a single frame. Based on such information, the frame builder 130 can calculate the amount of data to store therein in accordance with the attribute of a frame comprised of received packets. Besides, the number of frames to store may be different according to whether content needs seamless playback or quick playback. For example, if transmission of content is slow in light of a network state, the number of frames to store may be increased in accordance with this situation. Accordingly, a content attribute may include the number of frames, picture quality, information on playback and transmission of content, etc. Such information regarding the content attribute may be contained in a frame header.

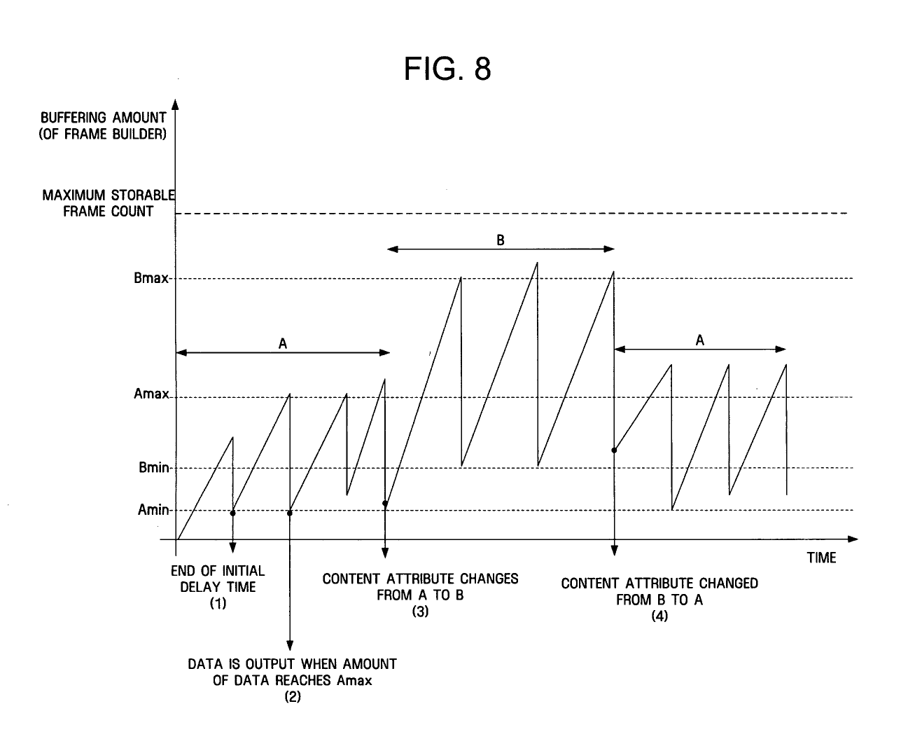

FIG. 8 is a graph showing the amounts of frame data stored in the frame builder 130, in an exemplary embodiment of the present invention. As illustrated in FIG. 7, when the attribute of received content changes, the amount of stored packets also changes.

It is assumed that there are two attributes A and B. Content with the attribute A may be a low bit rate content and prefer quick transmission to seamless transmission. Conversely, content with the attribute B may be a high bit rate content and prefer seamless transmission to quick transmission. In describing FIG. 8, it is assumed that the attribute A is a low bit rate while the attribute B is a high bit rate. Referring to FIG. 8, the amount of stored packets increases regularly and then decreases because packets are output to the frame pusher 140 when the number of frames corresponding to the stored packets reaches the maximum frame count.

When an initial delay time has lapsed (1), the frame builder 130 outputs content buffered in an initially needed amount because the number of frames corresponding to the initial delay time may be different from a maximum frame count or a minimum frame count. Maximum and minimum frame counts for the attribute A are referred to as Amax and Amin, respectively. When the frame builder 130 stores more frames than the maximum frame count Amax, it outputs frames. The delay controller 110 controls to keep the frame builder 130 storing more frames than the minimum frame count Amin.

When the number of stored in the frame builder 130 reaches the maximum frame count Amax (2), the frame builder 130 outputs packets. Thereafter, the frame builder 130 continuously outputs data maintaining the number of stored frames between the maximum frame count Amax and the minimum frame count Amin. Meanwhile, when content with the attribute B is transmitted due to better network performance, the maximum frame count and the minimum frame count may change. The maximum and minimum frame counts for the attribute B are referred to as a Bmax and a Bmin, respectively, and can be obtained based on received frame information. A storage pattern for content having the attribute B may be different from a storage pattern for content having the attribute A. When content having the attribute B is received (3), a storage pattern in which packets are stored in the frame builder 130 changes. Thereafter, when content having the attribute A is received (4) due to a degraded network state, the maximum and minimum frame counts change from the maximum frame count Bmax and the minimum frame count Bmin into the maximum frame count Amax and the minimum frame count Amin, respectively, and control is performed to keep the frame builder 130 storing data between the maximum frame count Amax and the minimum frame count Amin.

The maximum frame counts Amax and Bmax and the minimum frame counts Amin and Bmin are set by the frame building controller 135 so that the frame builder 130 recognizes the amount of data to keep therein.

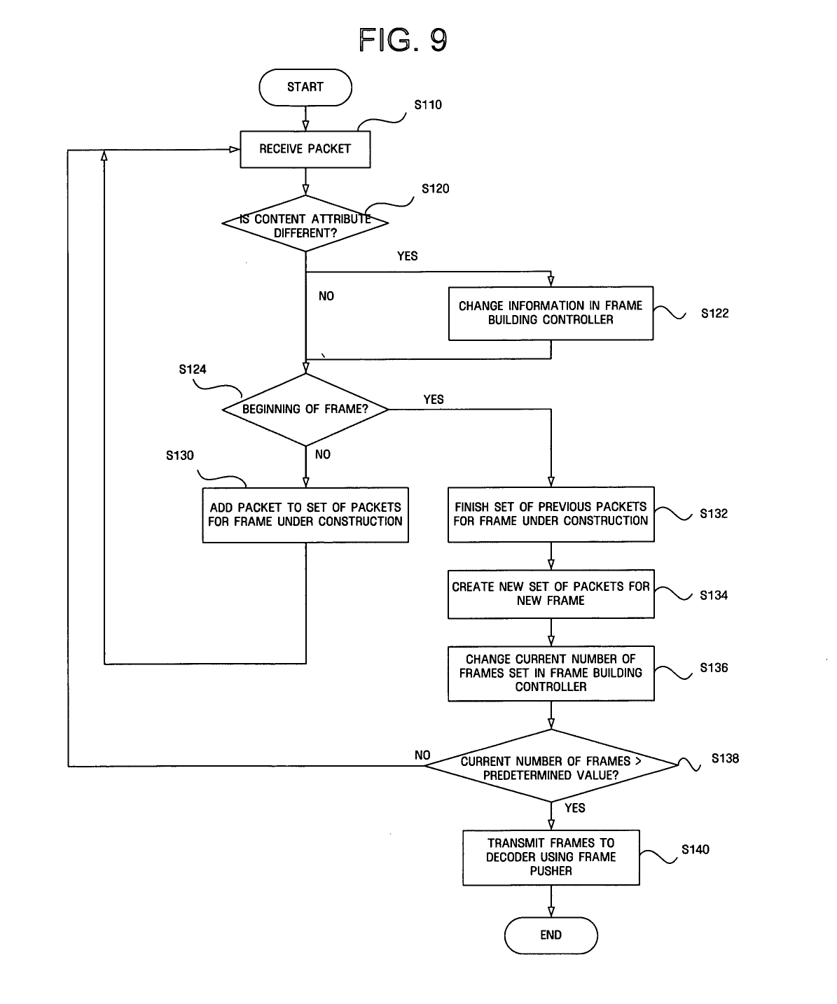

FIG. 9 is a flowchart of a procedure in which the streaming client 100 stores and outputs data in frame units according to an exemplary embodiment of the present invention.

In operation S110, the packet receiver 120 receives a packet included in frame in data that the network adapter 125 receives from the streaming server 900 and transmits the packet to the frame builder 130. In operation S120, the frame builder 130 inspects frame information of the packet to determine whether the packet has a different frame attribute than a previous packet. The frame attribute changes, for example, when high bit rate content is received after network traffic decreases while low bit rate content is received or when there was no frames received and thus no information needed to form a frame is present. If it is determined that the packet has a different frame attribute than the previous packet, information stored in the frame building controller 135 is changed in operation S122 and the procedure goes to operation S124. If it is determined that the packet has the same frame attribute as the previous packet, without performing operation S122, it is determined whether the packet is the beginning of a frame in operation S124.

If the packet is not the beginning of a frame and there is no frame under construction, content has been transmitted starting from not the beginning but somewhere in the middle. In other words, when a user selects a position corresponding to the middle of streamed multimedia, not a packet including the beginning of a frame but a packet corresponding to the middle of the frame is received. Such packets may be discarded since they cannot construct a complete frame. A set or collection of packets is a unit frame obtained by connecting packets for a frame through a link or by sequentially storing packets for a frame.

If the packet is not the beginning of a new frame but is included in a current frame under construction, the packet is added to a set (or collection) of packets sequentially stored for the construct of the current frame in operation S130. If the packet is the beginning of a new frame, a set (or collection) of previous packets for construction of a frame is finished in operation S132 since a frame constructed with the set of previous packets is different from the new frame of the packet received currently. After the finishing of the previous packets, a new set of packets for the new frame is created in operation S134 since the current packet is the first packet of the new frame.

Since packets for a single frame are finished, in operation S136 the current number of frames set in the frame building controller 135 is increased by one. In operation S138, it is determined whether the current number of frames exceeds a predetermined value, which may be a maximum frame count or a minimum frame count according to the state of a system. For example, if the current number of frames stored in the frame builder 130 exceeds a frame count enough to output taking account of a delay time, the frame pusher 140 takes frames from the frame builder 130 and pushes them to the decoder 150 in operation S140. Meanwhile, even when the current number of frames does not exceed the predetermined value in operation S138, frames stored in the frame builder 130 may be output until the current number of frames is less than or equal to the minimum frame count in order to continuously output content. This outputting operation may vary with a content attribute and a streaming point.

According to the apparatus and method, the amount of data stored in a buffer can be adaptively controlled in receiving AV data.

In addition, the amount of data stored in a buffer can be controlled according to the attribute of AV data, and therefore, a delay occurring in streaming of the AV data can be reduced.

It will be understood by those of ordinary skill in the art that various changes in form and details may be made therein without departing from the spirit and scope of the present invention as defined by the following claims. Therefore, it is to be appreciated that the above described exemplary embodiments is are for purposes of illustration only and not to be construed as a limitation of the invention. The scope of the invention is given by the appended claims, rather than the preceding description, and all variations and equivalents which fall within the range of the claims are intended to be embraced therein.

What is claimed is:

1. A method of adaptively controlling a buffering amount according to a content attribute in receiving audio-video data, the method comprising:
determining a number of frames to be stored according to frame information extracted from packets which are received;
connecting and storing the packets by the frames within a range of the number of the frames which is determined; and
outputting the packets connected and stored by the frames to a decoder.

2. The method of claim 1, wherein the frame information comprises one of picture quality of a frame, a rate of the frames per second, and a size of information constituting a single frame.

3. The method of claim 1, wherein the frame information comprises one of a transmission rate of content of a frame and information on playback of a content of the frame.

4. The method of claim 1, wherein the determining the number of the frames to be stored comprises calculating a delay time according to a network state in which the packets are received and determining the number of the frames to be stored based on the delay time.

5. The method of claim 1, wherein the connecting and storing the packets comprises creating and storing a link of packets for each frame.

6. The method of claim 1, wherein the connecting and storing the packets comprises sequentially storing the packets by the frames.

7. The method of claim 1, wherein the outputting the packets comprises outputting the packets stored by the frames to the decoder if a number of the frames corresponding to the packets which are stored exceeds the number of the frames to be stored which is determined.

8. The method of claim 1, further comprising controlling one of a push rate and a receiving rate of the packets if a number of the frames corresponding to the packets which are stored is less than the number of the frames to be stored which is determined.

9. An apparatus for adaptively controlling a buffering amount according to a content attribute in receiving audio-video data, the apparatus comprising:
a frame builder which connects and stores packets by frames;
a frame building controller which determines a number of the frames to be stored in the frame builder according to frame information extracted from the packets; and
a frame pusher which outputs the packets connected and stored by the frames in the frame builder to a decoder.

10. The apparatus of claim 9, wherein the frame builder creates a link of packets for each frame to connect and store the packets by the frames and comprises a frame management list to manage the frames.

11. The apparatus of claim 9, wherein the frame builder sequentially stores the packets by the frames to connect and store the packets by the frames, and the frame builder comprises a frame management list to manage the frames.

12. The apparatus of claim 9, wherein the frame information comprises one of picture quality of a frame, a rate of the frames per second, and a size of information constituting a single frame.

13. The apparatus of claim 9, wherein the frame information comprises one of a transmission rate of content of a frame and information on playback of a content of the frame.

14. The apparatus of claim 9, wherein the frame building controller calculates a delay time according to a network state in which the packets are received and determines the number of the frames to be stored based on the delay time.

15. The apparatus of claim 9, wherein the frame pusher outputs the packets stored by frames to the decoder if a number of the frames corresponding to the packets which are stored exceeds the number of the frames to be stored which is determined.

16. The apparatus of claim 9, further comprising a delay controller controlling one of a push rate and a receiving rate of packets if a number of the frames corresponding to the packets which are stored is less than the number of the frames to be stored which is determined.

17. A recording medium having a computer readable program recorded therein, the program for executing the method of adaptively controlling a buffering amount according to a content attribute in receiving audio-video data, the method comprising:
determining a number of frames to be stored according to frame information extracted from packets which are received;
connecting and storing the packets by the frames within a range of the number of the frames which is determined; and
outputting the packets connected and stored by the frames to a decoder.

18. An apparatus for receiving multimedia data by adaptively controlling a buffering amount according to a content attribute in receiving audio-video data, the apparatus comprising:
means for determining a number of frames to be stored according to frame information extracted from packets which are received;
means for connecting and storing the packets by the frames within a range of the number of the frames which is determined; and
means for outputting the packets connected and stored by the frames to a decoder.
